(19) United States
(12) Patent Application Publication
(10) Pub. No.: US 2026/0211301 A1
(43) Pub. Date: Jul. 23, 2026

(54) OPTICAL SYSTEM

(71) Applicant: Actutek Corporation, Taoyuan City (TW)

(72) Inventors: Chia-Che WU, Taoyuan City (TW); Chao-Chang HU, Taoyuan City (TW); Yi-Ho CHEN, Taoyuan City (TW); Szu-Yung HSIEH, Taoyuan City (TW); ShenFu CHIU, Taoyuan City (TW)

(21) Appl. No.: 19/456,712

(22) Filed: Jan. 22, 2026

Related U.S. Application Data
(60) Provisional application No. 63/748,691, filed on Jan. 23, 2025.

(51) Int. Cl. G03B 17/12

(52) U.S. Cl. CPC G03B 17/12

(57) ABSTRACT

An optical system is provided. The optical system includes an immovable part, a movable part, a first optical module, and a second optical module. The movable part is movable relative to the immovable part. The first optical module is coupled to the immovable part. The second optical module corresponds to the first optical module, and the second optical module is disposed in the movable part. Light passes through the first optical module before entering the second optical module.

### CROSS REFERENCE TO RELATED APPLICATIONS

This application claims the benefit of U.S. provisional application No. 63/748,691, filed on Jan. 23, 2025, the entirety of which is incorporated by reference herein.

### TECHNICAL FIELD

The present disclosure relates to an optical system, and, in particular, to an optical system including different optical modules.

### BACKGROUND

As technology has developed, many electronic devices (such as tablet computers and smartphones) may be used for capturing images and recording video. The optical system in the electronic device allows the user to use the electronic device to capture images and record video. When the electronic device is being used, shock or vibration may occur, and this may cause the images or video to come out blurry. Therefore, the demand for higher quality images and video is increasing.

### BRIEF SUMMARY

Some embodiments of the present disclosure provide an optical system. The optical system includes an immovable part, a movable part, a first optical module, and a second optical module. The movable part is movable relative to the immovable part. The first optical module is coupled to the immovable part. The second optical module corresponds to the first optical module, and the second optical module is disposed in the movable part. Light passes through the first optical module before entering the second optical module.

In some embodiments, the first optical module includes an aperture assembly, and the second optical module includes a lens assembly. In some embodiments, the second optical module is at least partially disposed within the first optical module.

In some embodiments, the immovable part includes a casing including a top surface recessed portion and a side surface recessed portion. In some embodiments, the casing further includes an opening exposing the first optical module, and a center of the opening is offset from a center of the casing. In some embodiments, the immovable part further includes a frame disposed in the casing, and the frame includes two protrusions disposed on opposite sides of the frame and configured to contact the casing. In some embodiments, the optical system further includes a first circuit element electrically connected to the first optical module and disposed on the casing.

In some embodiments, the first circuit element has an upper portion and a side portion, a shape of the upper portion of the first circuit element corresponds to the top surface recessed portion of the casing, and a shape of the side portion of the first circuit element corresponds to the side surface recessed portion of the casing. In some embodiments, the first optical module includes an electrical connection portion located between the upper portion of the first circuit element and the top surface recessed portion of the casing. In some embodiments, the upper portion of the first circuit element has a U-shaped configuration surrounding the first optical module.

In some embodiments, the optical system further includes a second circuit element electrically connected to the first circuit element. In some embodiments, the casing further includes a through hole for electrical connection between the first circuit element and the second circuit element.

In some embodiments, the optical system further includes an additional optical module corresponding to the first optical module. In some embodiments, the first optical module includes an aperture assembly, and the second optical module and the additional optical module each includes a lens assembly. In some embodiments, the additional optical module is disposed between the first optical module and the second optical module. In some embodiments, the first optical module is disposed between the second optical module and the additional optical module. In some embodiments, wherein at least one of the second optical module and the additional optical module is at least partially disposed within the first optical module.

In some embodiments, the first optical module includes a supporting pad disposed on the immovable part.

In some embodiments, the optical system further includes a drive assembly driving the movable part to move relative to the immovable part and an elastic assembly configured to provide an elastic force to the movable part, wherein the drive assembly includes a plurality of coils, a surrounding coil surrounding the movable part, and a plurality of magnetic elements, and the elastic assembly includes a plurality of upper elastic elements, a plurality of extending elastic elements each connected to the corresponding upper elastic element, and a plurality of lower elastic elements. In some embodiments, the optical system further includes a sensing assembly sensing the movement of the movable part relative to the immovable part.

### BRIEF DESCRIPTION OF THE DRAWINGS

The present disclosure can be more fully understood by reading the subsequent detailed description and examples with references made to the accompanying drawings.

FIG. 1 is a schematic view of an electronic device including an optical system, in accordance with some embodiments.

FIG. 2 is a perspective view of the optical system, in accordance with some embodiments.

FIG. 3 is a top view of the optical system of FIG. 2, in accordance with some embodiments.

FIG. 4 is an exploded view of the optical system, in accordance with some embodiments.

FIGS. 5 and 6 are perspective views of the casing and the frame, in accordance with some embodiments.

FIG. 7 is a perspective view of the first optical module and the first circuit element, in accordance with some embodiments.

FIG. 8 is a perspective view of the second circuit element, in accordance with some embodiments.

FIG. 9 is a perspective view of the optical system with the casing omitted, in accordance with some embodiments.

FIG. 10 is a top view of the optical system of FIG. 9, in accordance with some embodiments.

FIG. 11 is a perspective view of the optical system, with the casing, the first optical module, and the first circuit element omitted, in accordance with some embodiments.

FIG. 12 is a perspective view of the optical system, with the frame further omitted, in accordance with some embodiments.

FIG. 13 is a perspective view of the optical system further including a additional optical module between the first optical module and the second optical module, in accordance with some embodiments.

FIGS. 14 and 15 are perspective views of the optical system further including a additional optical module disposed on the first optical module, in accordance with some embodiments.

### DETAILED DESCRIPTION

The following disclosure provides many different embodiments, or examples, for implementing different features of the subject matter provided. Specific examples of components and arrangements are described below to simplify this disclosure. These are, of course, merely examples and are not intended to be limiting. For example, the formation of a first feature “on” and/or “above” a second feature in the description that follows may include embodiments in which the first and second features are formed in direct contact, and may also include embodiments in which additional features may be formed between the first and second features, so that the first and second features may not be in direct contact. The spatially relative terms are intended to encompass different orientations of the device in use or operation in addition to the orientation depicted in figures. The apparatus may be otherwise oriented (rotated 90 degrees or at other orientations) and the spatially relative descriptors used herein may likewise be interpreted accordingly. In addition, in different examples of this disclosure, symbols or alphabets may be used repeatedly.

Ordinal terms such as “first”, “second”, etc., used in the description and in claims do not by themselves connote any priority, precedence, or order of one element over another, but are used merely as labels to distinguish one element from another element having the same name. Unless the context requires otherwise, throughout the specification and claims that follow, the word “include”, “have” and variations thereof, such as “includes”, “including”, “having” are to be construed in an open, inclusive sense, that is, as “including, but not limited to.”

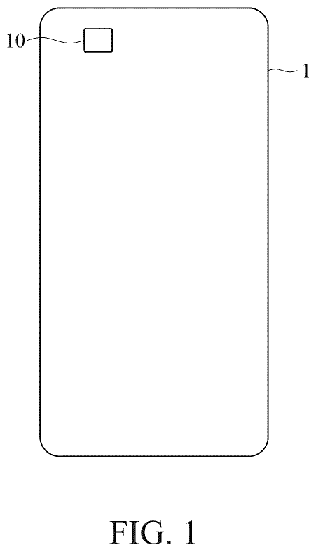

Referring to FIG. 1, which illustrates a schematic view of an electronic device 1 including an optical system 10, in accordance with some embodiments. The electronic device 1 may be a smartphone, a tablet, etc. The optical system 10 may be used to capture images or video. Light from a scene may pass through one or more lenses (such as “the second optical module” and/or “the additional optical module” described below) included in the optical system 10, and the lenses may focus the incoming light onto an image sensor (such as “the third optical module” described below). In the present disclosure, the optical system 10 may provide autofocus (AF), optical image stabilization (OIS), sensor shift, and aperture control functions.

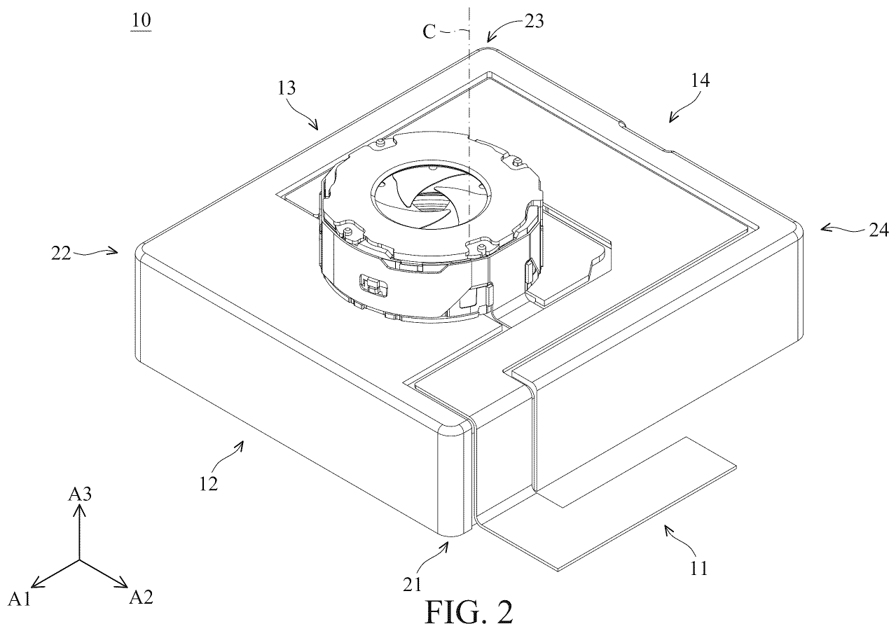

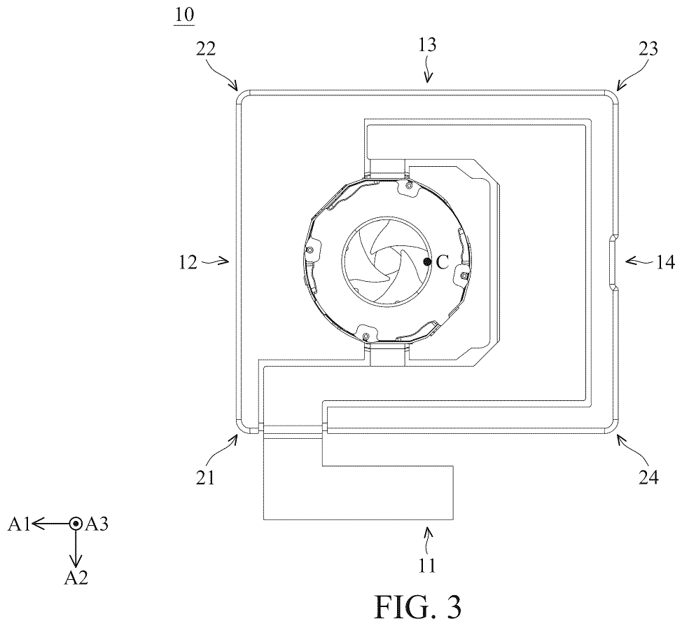

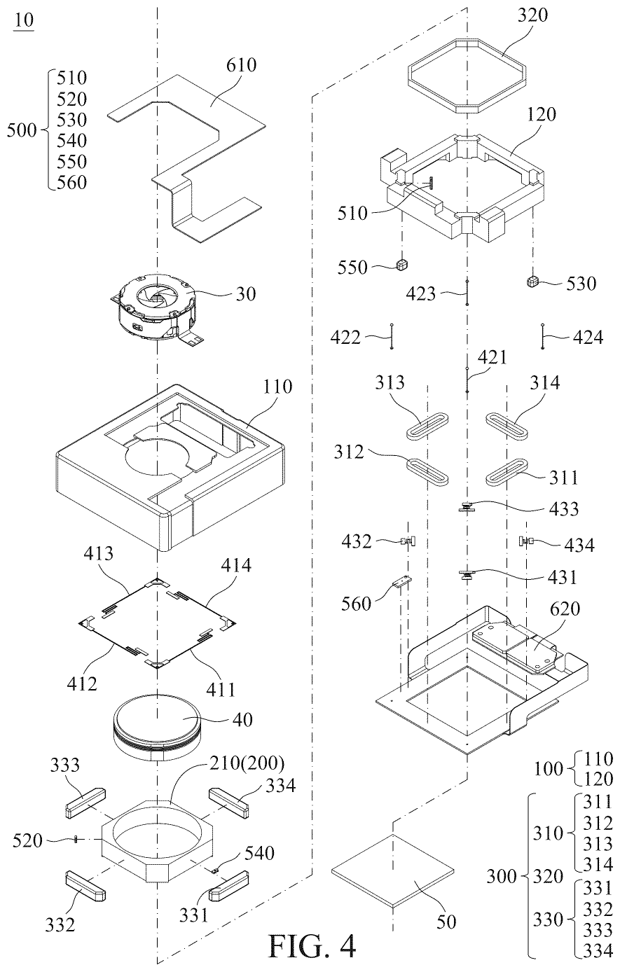

Referring to FIGS. 2 to 4, various views of the optical system 10 are illustrated. FIG. 2 is a perspective view of the optical system 10, in accordance with some embodiments. FIG. 3 is a top view of the optical system 10 of FIG. 2, in accordance with some embodiments. FIG. 4 is an exploded view of the optical system 10, in accordance with some embodiments.

The optical system 10 includes a central axis C passing through its center. From a top view, the optical system 10 may be polygonal, such as quadrilateral. For ease of illustration, the four sides of the optical system 10 are referred to as a first side 11, a second side 12, a third side 13, and a fourth side 14. The first side 11 is opposite the third side 13, and the second side 12 is opposite the fourth side 14. The first side 11 and the third side 13 are substantially parallel with a first axis A1. The second side 12 and the fourth side 14 are substantially parallel with a second axis A2. The first side 11, the second side 12, the third side 13, and the fourth side 14 are substantially perpendicular to a third axis A3. The first axis A1, the second axis A2, and the third axis A3 are substantially perpendicular to each other.

In addition, for ease of illustration, the four corners of the optical system 10 are referred to as a first corner 21, a second corner 22, a third corner 23, and a fourth corner 24. The first corner 21 is located between the first side 11 and the second side 12. The second corner 22 is located between the second side 12 and the third side 13. The third corner 23 is located between the third side 13 and the fourth side 14. The fourth corner 24 is located between the fourth side 14 and the first side 11.

A first optical module 30, a second optical module 40, and a third optical module 50 may be included in the optical system 10.

The first optical module 30 may include an aperture assembly to control the amount of light entering the optical system 10. The second optical module 40 may include a lens assembly that includes one or more lenses made of plastic materials or glasses. The third optical module 50 may be an image sensor, such as a charge-coupled device (CCD) or a complementary metal oxide semiconductor (CMOS) image sensor (CIS). Specifically, light entering the optical system 10 first passes through the first optical module 30, then passes through the second optical module 40, and is subsequently converted into an image on the third optical module 50.

In some embodiments, the first optical module 30 may include a receiving space receiving at least part of the second optical module 40. That is, the second optical module 40 is at least partially disposed within the first optical module 30. Therefore, the space may be utilized to achieve miniaturization.

The optical system 10 includes an immovable part 100, a movable part 200, a drive assembly 300, an elastic assembly 400, a sensing assembly 500, a first circuit element 610, and a second circuit element 620. The first optical module 30 is coupled to the immovable part 100, the second optical module 40 is coupled to the movable part 200, and the third optical module 50 is coupled to the second circuit element 620. In the present disclosure, the first optical module 30 is immovable, while the second optical module 40 and the third optical module 50 are movable.

The movable part 200 is movable relative to the immovable part 100. The drive assembly 300 drives the movable part 200 to move relative to the immovable part 100. The elastic assembly 400 is connected to the immovable part 100 and the movable part 200. The elastic assembly 400 is configured to provide an elastic force on the movable part 200. The sensing assembly 500 detects the movement of the movable part 200 relative to the immovable part 100. The first circuit element 610 and the second circuit element 620 are configured to provide electrical connection. For example, current may be transmitted within the optical system 10 through the first circuit element 610 and/or the second circuit element 620.

In this embodiment, the immovable part 100 includes a casing 110 and a frame 120. The movable part 200 includes a holder 210, which may be hollow to receive the second optical module 40. The drive assembly 300 includes a first coil 311, a second coil 312, a third coil 313, a fourth coil 314, a surrounding coil 320, a first magnetic element 331, a second magnetic element 332, a third magnetic element 333, and a fourth magnetic element 334. The elastic assembly 400 includes a plurality of upper elastic elements 411, 412, 413, 414, a plurality of extending elastic elements 421, 422, 423, 424, and a plurality of lower elastic elements 431, 432, 433, 434. The sensing assembly 500 includes a first reference element 510, a first sensing element 520, a second reference element 530, a second sensing element 540, a third reference element 550, and a third sensing element 560.

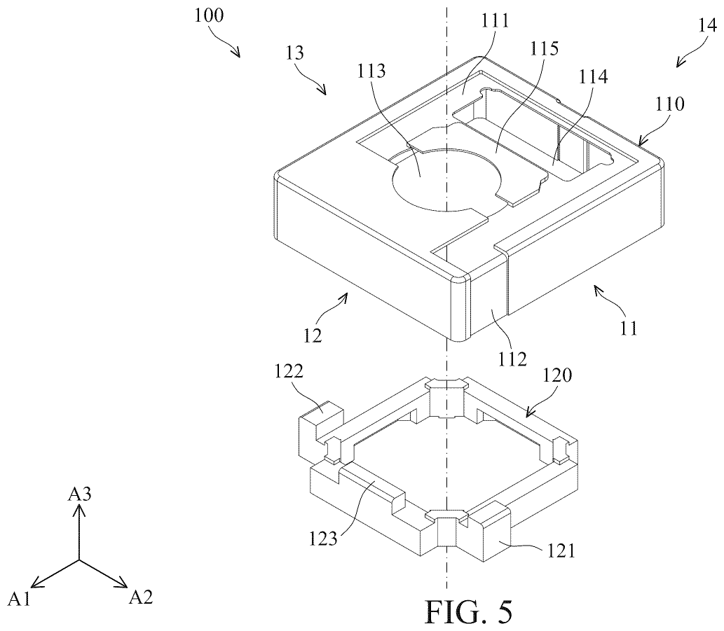

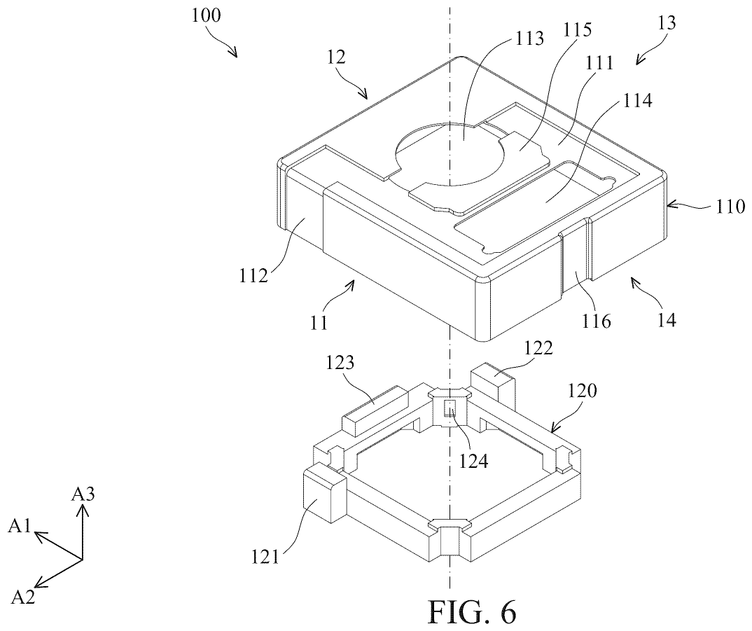

Next, in addition to FIGS. 2 to 4, referring to FIGS. 5 and 6 for details of the immovable part 100. FIGS. 5 and 6 are perspective views of the casing 110 and the frame 120, in accordance with some embodiments.

A receiving space may be formed within the casing 110 to accommodate the frame 120, the holder 210, the drive assembly 300, the elastic assembly 400, the sensing assembly 500, and the like. The casing 110 includes a top surface substantially perpendicular to the central axis C and a plurality of side surfaces substantially parallel with the central axis C. Specifically, the casing 110 includes a top surface recessed portion 111, a first side surface recessed portion 112, an opening 113, a through hole 114, a strengthening portion 115, and a second side surface recessed portion 116.

The top surface recessed portion 111 is formed on the top surface of the casing 110. The first side surface recessed portion 112 is formed on a side surface of the casing 110. The first side surface recessed portion 112 is close to the first corner 21 of the optical system 10. The opening 113 exposes the first optical module 30. In some embodiments, the opening 113 is circular. The center of the opening 113 is offset from the center of the casing 110 due to the presence of the first circuit element 610. In other words, the first optical module 30 is eccentrically disposed on the optical system 10.

The through hole 114 allows electrical contact and/or physical contact between the first circuit element 610 and the second circuit element 620. The strengthening portion 115 is located between the opening 113 and the through hole 114. In some embodiments, the thickness of the strengthening portion 115 is greater than the thickness of the top surface recessed portion 111, and thus the strengthening portion 115 may provide higher structural strength. The second side surface recessed portion 116 is formed on the fourth side 14 of the optical system 10.

The frame 120 is disposed within the casing 110. The frame 120 includes a first protrusion 121, a second protrusion 122, a third protrusion 123, and a recess 124. The first protrusion 121 is located on the first side 11 of the optical system 10 and is close to the first corner 21 of the optical system 10. The first protrusion 121 protrudes from a side surface of the frame 120. The second protrusion 122 is located on the third side 13 of the optical system 10 and is close to the second corner 22 of the optical system 10. The second protrusion 122 protrudes from a side surface of the frame 120 that is opposite to the side surface from which the first protrusion 121 protrudes. In other words, the first protrusion 121 and the second protrusion 122 are disposed on opposite sides of the frame 120. In some embodiments, the first protrusion 121 and the second protrusion 122 are symmetrically formed.

The third protrusion 123 is located on the second side 12 of the optical system 10. Since the first circuit element 610 is primarily disposed on the first side 11, the third side 13, and the fourth side 14 of the optical system 10, more space is available on the second side 12. Accordingly, the third protrusion 123 protrudes from a top surface, rather than a side surface, of the frame 120 to utilize the space under the casing 110 on the second side 12 of the optical system 10. As a result, space within the casing 110 is more effectively utilized, thereby facilitating miniaturization of the optical system 10.

The first protrusion 121, the second protrusion 122, and the third protrusion 123 are configured to contact the casing 110, thereby strengthening the connection between the casing 110 and the frame 120 and/or enhancing the structural strength of the optical system 10.

The recess 124 is formed on the second corner 22 of the optical system 10. The recess 124 is formed on an inner surface of the frame 120. The recess 124 may be used to accommodate the first reference element 510. The frame 120 may include other recesses for accommodate other elements.

Next, referring back to FIGS. 2 to 4, further details of the drive assembly 300, the elastic assembly 400, and the sensing assembly 500 are described.

The first coil 311 is disposed on the first side 11 of the optical system 10. The second coil 312 is disposed on the second side 12 of the optical system 10. The third coil 313 is disposed on the third side 13 of the optical system 10. The fourth coil 314 is disposed on the fourth side 14 of the optical system. In some embodiments, the first coil 311, the second coil 312, the third coil 313, and the fourth coil 314 are disposed on the second circuit element 620. The surrounding coil 320 surrounds the holder 210. In some embodiments, the shape of the surrounding coil 320 and the shape of the holder 210 are substantially the same. For example, if the holder 210 is octagonal, the surrounding coil 320 is also octagonal.

The first magnetic element 331 is disposed on the first side 11 of the optical system 10 and above the first coil 311. The second magnetic element 332 is disposed on the second side 12 of the optical system 10 and above the second coil 312. The third magnetic element 333 is disposed on the third side 13 of the optical system 10 and above the third coil 313. The fourth magnetic element 334 is disposed on the fourth side 14 of the optical system 10 and above the fourth coil 314. In some embodiments, the first magnetic element 331, the second magnetic element 332, the third magnetic element 333, and the fourth magnetic element 334 are disposed on the frame 120.

The first coil 311 and the corresponding first magnetic element 331, the second coil 312 and the corresponding second magnetic element 332, the third coil 313 and the corresponding third magnetic element 333, and the fourth coil 314 and the corresponding fourth magnetic element 334 are configured to generate magnetic forces for enabling OIS and/or sensor shift functions. In addition, the surrounding coil 320 and the first magnetic element 331, the second magnetic element 332, the third magnetic element 333, and the fourth magnetic element 334 are configured to generate magnetic forces for AF function. By distributing the coils and magnetic elements in this manner, the optical system 10 may achieve precise and independent control of multiple functions, reduce interference between OIS and AF operations, and maintain a compact and efficient assembly within the optical system 10.

It should be noted that the first magnetic element 331, the second magnetic element 332, the third magnetic element 333, and the fourth magnetic element 334 may be utilized in both the AF drive assembly and the OIS drive assembly. By employing the same magnetic elements for multiple drive functions, each magnetic element may simultaneously contribute to different operational mechanisms within the optical system 10. This multifunctional utilization reduces the total number of magnetic components required, thereby decreasing the overall volume of the optical system 10. Consequently, the compact arrangement of these magnetic elements facilitates miniaturization of the optical system 10 without compromising the performance of either the AF or OIS functions.

The driving forces may be transmitted from the second circuit element 620 to the movable part 200 through the elastic assembly 400.

The upper elastic elements 411, 412, 413, 414 and the lower elastic element 431, 432, 433, 434 may be made of an elastic or ductile material, such as metal. In the technical field, the upper elastic elements 411, 412, 413, 414 and the lower elastic element 431, 432, 433, 434 may be referred to as a “spring”, “leaf spring”, “plate spring,” or other similar terms.

The upper elastic element 411 extends along the first side 11 of the optical system 10. The upper elastic element 412 extends along the second side 12 of the optical system 10. The upper elastic element 413 extends along the third side 13 of the optical system 10. The upper elastic element 414 extends along the fourth side 14 of the optical system 10. The upper elastic elements 411, 412, 413, 414 are connected to the upper surface of the holder 210 and the upper surface of the frame 120.

The lower elastic element 431 is disposed on the first corner 21 of the optical system 10. The lower elastic element 432 is disposed on the second corner 22 of the optical system 10. The lower elastic element 433 is disposed on the third corner 23 of the optical system 10. The lower elastic element 434 is disposed on the fourth corner 24 of the optical system 10. The lower elastic element 431, 432, 433, 434 are connected to the lower surface of the holder 210 and the surface of the second circuit element 620 that faces the holder 210.

When the holder 210 moves relative to the immovable part 100, the range of motion of the holder 210 may be restricted by the upper elastic elements 411, 412, 413, 414 and the lower elastic element 431, 432, 433, 434. As a result, the holder 210 and the second optical module 40 housed therein are protected from damage due to collision with the casing 110 or the frame 120 during motion of the optical system 10 or under external impact, because the upper elastic elements 411, 412, 413, 414 and the lower elastic element 431, 432, 433, 434 provide resilient support to maintain alignment and stability of the holder 210.

The upper ends of the four extending elastic elements 421, 422, 423, 424 are connected to the upper elastic elements 411, 412, 413, 414, respectively, and the lower ends of the four extending elastic elements 421, 422, 423, 424 are connected to the second circuit element 620. With the flexible extending elastic elements 421, 422, 423, 424, the movement of the second circuit element 620 together with the third optical module 50 are two-dimensional in directions that are perpendicular to the optical axis of the second optical module 40. In some other embodiments, the extending elastic elements 421, 422, 423, 424 may be omitted, and the second circuit element 620 is supported by other support elements, such as balls.

The sensing assembly 500 may provide real-time feedback for controlling the optical system 10, improving precision of functions such as AF, OIS, sensor shift, and the like.

The first reference element 510, the second reference element 530, and the third reference element 550 may be a magnetic element. The first sensing element 520, the second sensing element 540, and the third sensing element 560 may a Hall element, a giant magnetoresistive (GMR) element, a tunneling magnetoresistive (TMR) element, and the like. In some embodiments, at least one of the first sensing element 520, the second sensing element 540, and the third sensing element 560 may be a Hall sensor, a GMR sensor, a TMR sensor, etc.

A Hall sensor, a GMR sensor, or a TMR sensor means that other elements such as an amplifier circuit, a temperature-compensation circuit, and a power voltage-stabilization circuit are integrated into the sensor in addition to the Hall element, the GMR element, and the TMR element. Such a sensor is referred to as an All-in-One integrated circuit (All-in-One IC). After current is supplied to an All-in-One IC, the All-in-One IC may supply the current to the other elements. In some embodiments, the All-in-One IC includes a plurality of pins. The All-in-One IC has the ability to control other elements, for example, it may control OIS functions of the optical system 10.

The first reference element 510 and the first sensing element 520 are disposed on the second corner 22 of the optical system 10. In some embodiments, the first sensing element 520 may be provided on a side surface of the holder 210, facing the first reference element 510 that is disposed on the frame 120. The first sensing element 520 may sense changes in the magnetic field of the first reference element 510, including, but not limited to, the density of the lines of magnetic field and the direction of the lines of magnetic field, to determine the position of the holder 210 along an optical axis of the second optical module 40.

The second reference element 530 and the second sensing element 540 are disposed on the fourth corner 24 of the optical system 10. In some embodiments, the second sensing element 540 may be provided on the second circuit element 620, facing the second reference element 530 that is disposed on the frame 120. The second sensing element 540 may sense changes in the magnetic field of the second reference element 530, including, but not limited to, the density of the lines of magnetic field and the direction of the lines of magnetic field, to determine the position of the holder 210 along a direction that is perpendicular to an optical axis of the second optical module 40.

The third reference element 550 and the third sensing element 560 are disposed on the second corner 22 of the optical system 10. In some embodiments, the third sensing element 560 may be provided on the second circuit element 620, facing the third reference element 550 that is disposed on the frame 120. The third sensing element 560 may sense changes in the magnetic field of the third reference element 550, including, but not limited to, the density of the lines of magnetic field and the direction of the lines of magnetic field, to determine the position of the holder 210 along another direction that is perpendicular to an optical axis of the second optical module 40.

Accordingly, the combination of the first reference element 510 and the first sensing element 520 may be referred to as an AF sensing assembly, while the combination of the second reference element 530, the second sensing element 540, the third reference element 550, and the third sensing element 560 may be referred to as an OIS sensing assembly.

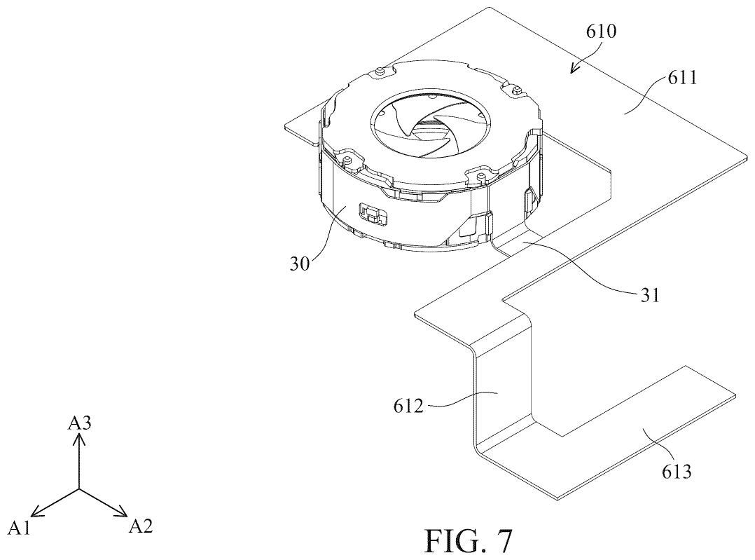

Next, in addition to FIGS. 2 to 4, referring FIG. 7 for a detailed illustration of the first circuit element 610. FIG. 7 is a perspective view of the first optical module 30 and the first circuit element 610, in accordance with some embodiments.

The first circuit element 610 may be a circuit board, such as a rigid board, a flexible board, a rigid-flex board, or a flexible printed circuit (FPC). The first circuit element 610 is disposed on the casing 110. The first circuit element 610 includes an upper portion 611, a side portion 612, and a lower portion 613. In some embodiments, the upper portion 611 of the first circuit element 610 has a U-shaped configuration surrounding the first optical module 30. The side portion 612 is disposed on the first side 11 of the optical system 10 and close to the first corner 21 of the optical system 10.

The shape of the upper portion 611 of the first circuit element 610 may correspond to the top surface recessed portion 111 of the casing 110, and/or the shape of the side portion 612 of the first circuit element 610 may correspond to the first side surface recessed portion 112 of the casing 110. In this manner, the likelihood of the first circuit element 610 detaching from the casing 110 may be reduced, thereby improving the reliability and durability of the optical system 10.

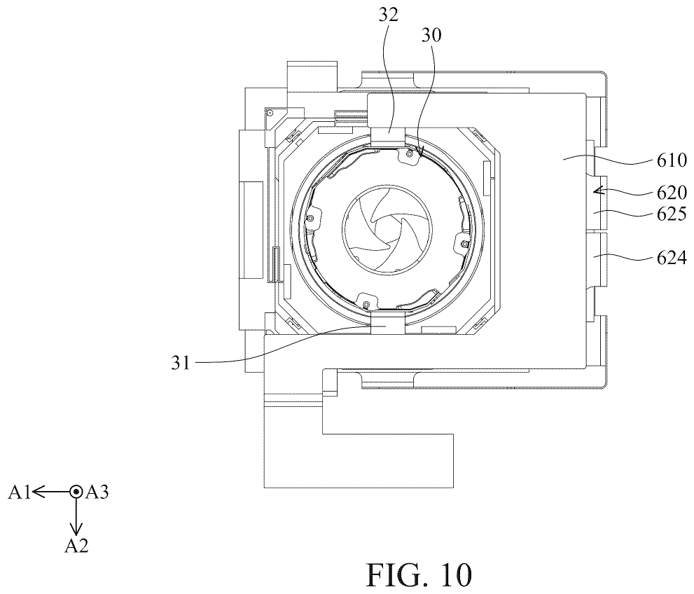

In addition, the first circuit element 610 is electrically connected to the first optical module 30 through a first electrical connection portion 31 and a second electrical connection portion 32 (labeled in FIG. 10). In some embodiments, the first electrical connection portion 31 and the second electrical connection portion 32 both located between the upper portion 611 of the first circuit element 610 and the top surface recessed portion 111 of the casing 110. This may ensure stable electrical connection between the first circuit element 610 and the first optical module 30.

Furthermore, the first optical module 30 is coupled to the casing 110 (i.e., immovable part 100) of the optical system 10. Compared to other arrangements in which the first optical module 30 is coupled to a movable part of the optical system, the present configuration may reduce the weight of the part to be driven and simplify circuit routing, since the entire first optical module 30 does not move together with the movable part 200. Furthermore, assembly of the optical system 10 may be simplified because the first optical module 30 does not need to be integrated into the interior of the movable part.

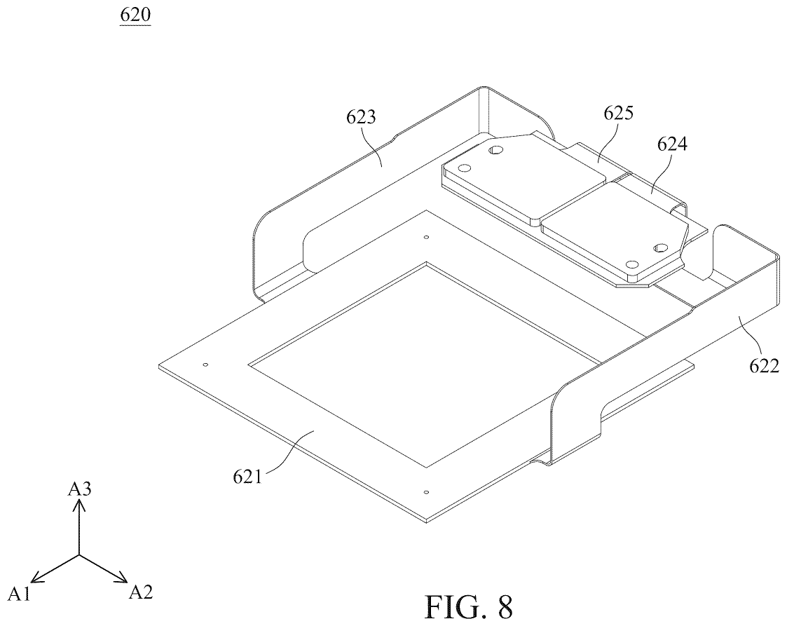

Next, in addition to FIGS. 2 to 4, referring FIG. 8 for a detailed illustration of the second circuit element 620. FIG. 8 is a perspective view of the second circuit element 620, in accordance with some embodiments.

The second circuit element 620 may be a flexible printed circuit (FPC). The second circuit element 620 includes a main body 621, a first side portion 622, a second side portion 623, a first electrical element 624, and a second electrical element 625. The main body 621 may be hollow to receive the third optical module 50. The first side portion 622 is disposed on the first side 11 of the optical system 10. The second side portion 623 is disposed on the third side 13 of the optical system 10. The first side portion 622 and the second side portion 623 extend from opposite sides of the main body 621. The first electrical element 624 and the second electrical element 625 are disposed on the fourth side 14 of the optical system 10. The first side portion 622, the second side portion 623, the first electrical element 624, and the second electrical element 625 are bent upward relative to the main body 621 to form retaining edges.

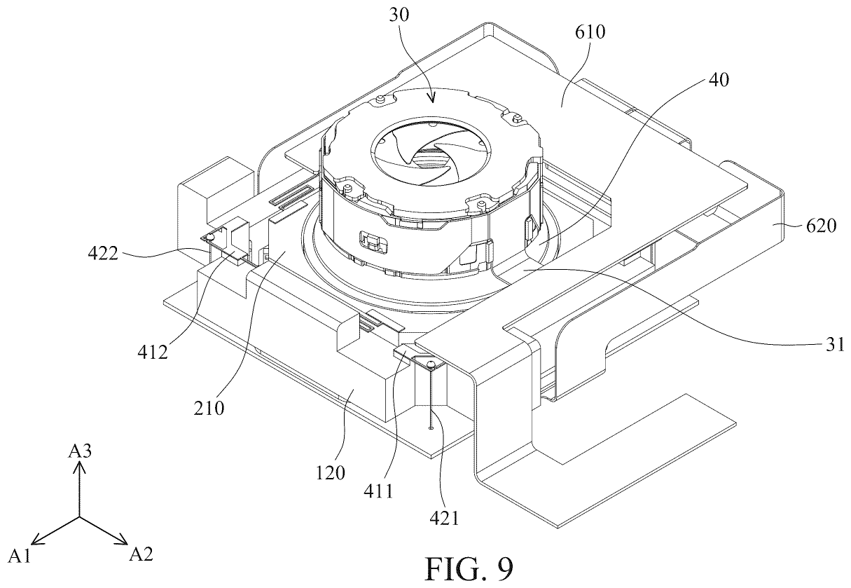

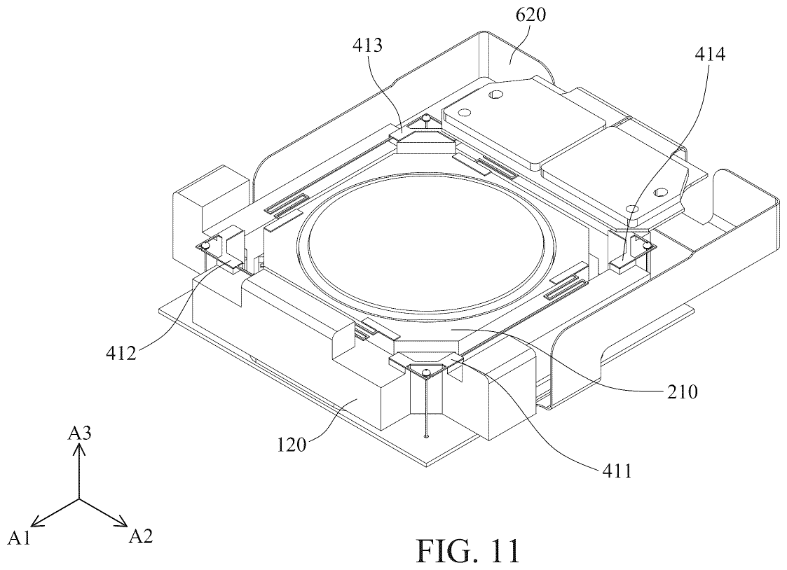

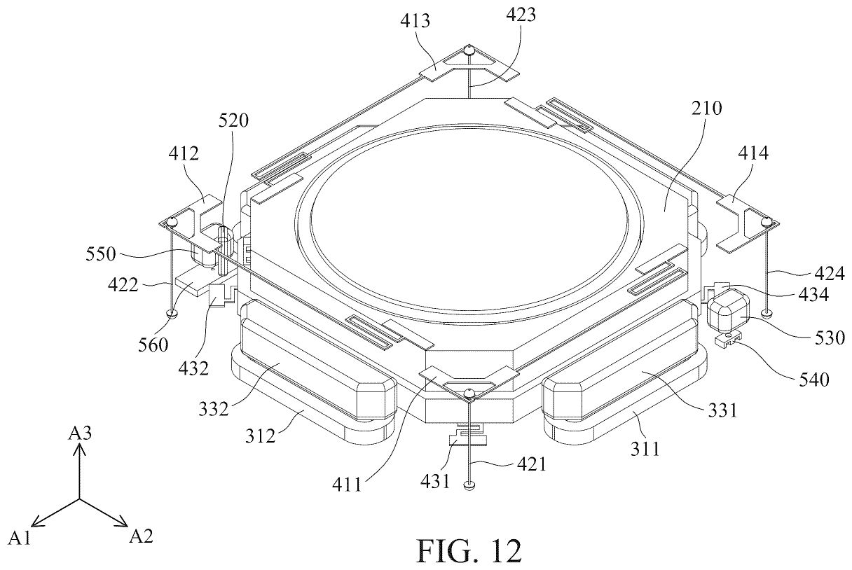

FIGS. 9 to 12 are provided to illustrate various aspects of the optical system 10 in greater detail, including the positional relationships, spatial arrangements, and relative orientations of different elements within the optical system 10. FIG. 9 is a perspective view of the optical system 10 with the casing 110 omitted, in accordance with some embodiments. FIG. 10 is a top view of the optical system 10 of FIG. 9, in accordance with some embodiments. FIG. 11 is a perspective view of the optical system 10, with the casing 110, the first optical module 30, and the first circuit element 610 omitted, in accordance with some embodiments. FIG. 12 is a perspective view of the optical system 10, with the frame 120 further omitted, in accordance with some embodiments.

For example, how the upper elastic element 412 is connected to the holder 210 and the frame 120 may be understood from FIG. 9. Also, the electrical connection between the first circuit element 610 and the second circuit element 620 via the first electrical element 624 and the second electrical element 625 may be understood from FIGS. 9 and 11. The arrangement of the drive assembly 300 and the sensing assembly 500 may be understood from FIG. 12.

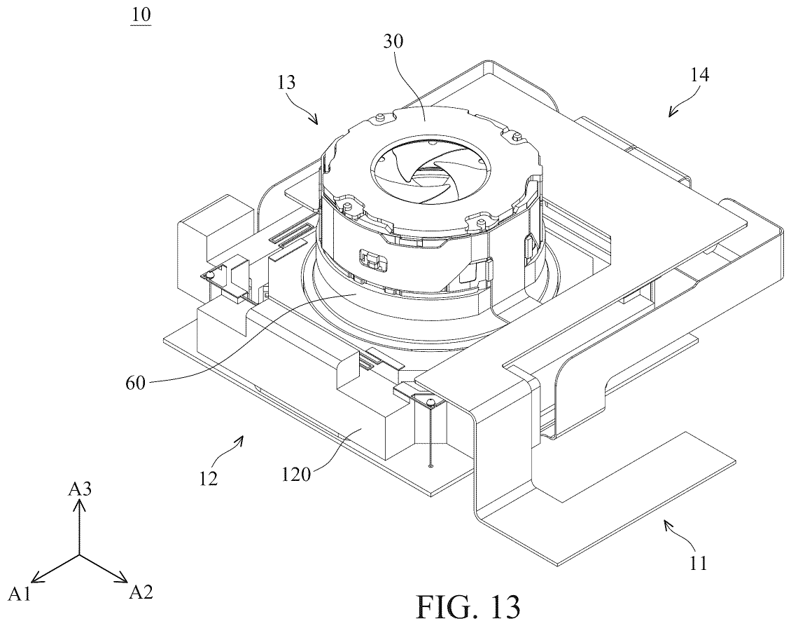

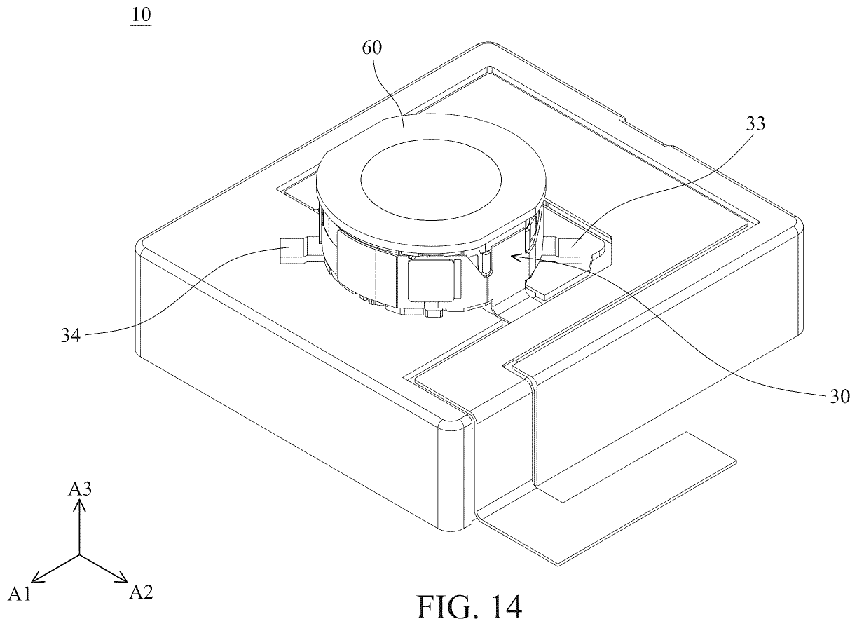

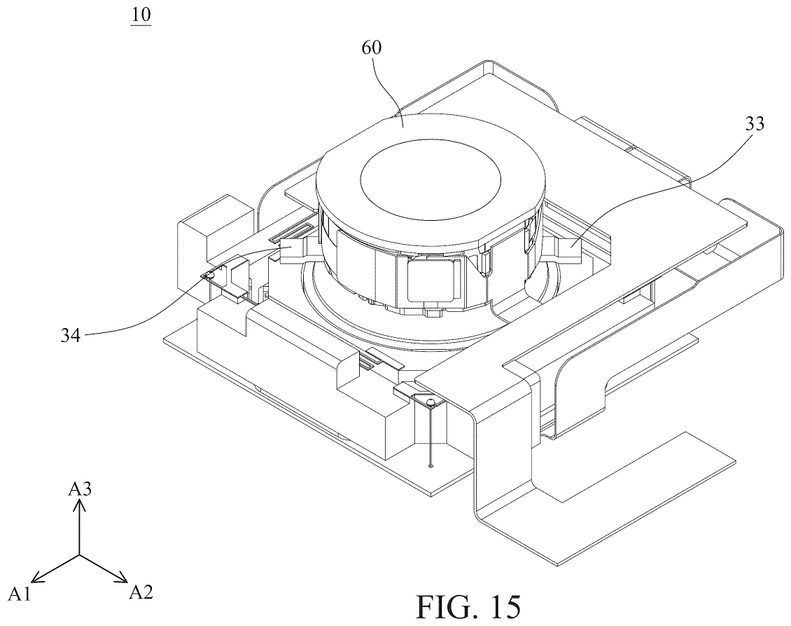

It should be noted that an additional optical module may be included in the optical system 10. FIG. 13 is a perspective view of the optical system 10 further including an additional optical module 60 between the first optical module 30 and the second optical module 40, in accordance with some embodiments. FIGS. 14 and 15 are perspective views of the optical system 10 further including an additional optical module 60 disposed on the first optical module 30, in accordance with some embodiments.

The additional optical module 60 may include a lens assembly. By incorporating the additional optical module 60, the optical system 10 may provide zoom capability, thereby functioning as a zoom optical system. For example, the additional optical module 60 may cooperate with the second optical module 40 to adjust the overall focal length and field of view, enabling smooth transitions between wide-angle and telephoto imaging modes. The inclusion of the additional optical module 60 may enhance the performance of the optical system 10 without substantially increasing its overall size.

In the embodiments illustrated in FIG. 13, the additional optical module 60 is disposed between the first optical module 30 and the second optical module 40. The first optical module 30 may include a receiving space for receiving the additional optical module 60 and/or at least part of the second optical module 40.

In the embodiments illustrated in FIGS. 14 and 15, the first optical module 30 is disposed between the second optical module 40 and the additional optical module 60. The first optical module 30 may include an upper receiving space for receiving at least part of the additional optical module 60 and/or a lower receiving space for receiving at least part of the second optical module 40.

In other words, in the embodiments where the additional optical module 60 is included, at least one of the second optical module 40 and the additional optical module 60 may be at least partially disposed within the first optical module 30. Therefore, the space may be utilized to achieve miniaturization.

Moreover, as shown in FIGS. 14 and 15, in some embodiments, the first optical module 30 further includes at least one supporting pad 33, 34 disposed on the immovable part 100. Each supporting pad 33, 34 may provide additional contact points between the first optical module 30 and the immovable part 100. The supporting pad(s) 33, 34 may be formed of a material that provides cushioning, vibration damping, or enhanced friction, thereby improving the mechanical stability of the first optical module 30 when coupled to the immovable part 100. As a result, the risk of undesired displacement, tilting, or detachment of the first optical module 30 during operation or handling may be significantly reduced, ensuring more reliable optical alignment and consistent performance of the optical system 10.

As described above, an optical system including multiple optical modules is provided. Different optical modules may be driven by a drive assembly, reducing the number of elements and contributing to miniaturization of the optical system. In addition, the movement of movable part may be sensed by a sensing assembly to provide real-time feedback for controlling the optical system. Moreover, by coupling the first optical module to the immovable part rather than the movable part, the optical system benefits from a reduction in the weight of movable components, simplified circuit routing, and streamlined assembly. This configuration enhances manufacturability and reliability while maintaining the functional performance of the optical system.

The foregoing outlines features of several embodiments so that those skilled in the art may better understand the aspects of this disclosure. Those skilled in the art should appreciate that they may readily use this disclosure as a basis for designing or modifying other processes and structures for carrying out the same purposes and/or achieving the same advantages of the embodiments introduced herein. Those skilled in the art should also realize that such equivalent constructions do not depart from the spirit and scope of this disclosure, and that they may make various changes, substitutions, and alterations herein without departing from the spirit and scope of this disclosure. In addition, the scope of this disclosure is not limited to the specific embodiments described in the specification, and each claim constitutes a separate embodiment, and the combination of various claims and embodiments are within the scope of the disclosure.

What is claimed is:

1. An optical system, comprising:
an immovable part;
a movable part movable relative to the immovable part;
a first optical module coupled to the immovable part; and
a second optical module corresponding to the first optical module and disposed in the movable part,
wherein a light passes through the first optical module before entering the second optical module.

2. The optical system as claimed in claim 1, wherein the first optical module comprises an aperture assembly, and the second optical module comprises a lens assembly.

3. The optical system as claimed in claim 2, wherein the second optical module is at least partially disposed within the first optical module.

4. The optical system as claimed in claim 1, wherein the immovable part comprises a casing comprising a top surface recessed portion and a side surface recessed portion.

5. The optical system as claimed in claim 4, wherein the casing further comprises an opening exposing the first optical module, and a center of the opening is offset from a center of the casing.

6. The optical system as claimed in claim 4, wherein the immovable part further comprises a frame disposed in the casing, and the frame comprises two protrusions disposed on opposite sides of the frame and configured to contact the casing.

7. The optical system as claimed in claim 4, further comprising a first circuit element electrically connected to the first optical module and disposed on the casing.

8. The optical system as claimed in claim 7, wherein the first circuit element has an upper portion and a side portion, a shape of the upper portion of the first circuit element corresponds to the top surface recessed portion of the casing, and a shape of the side portion of the first circuit element corresponds to the side surface recessed portion of the casing.

9. The optical system as claimed in claim 8, wherein the first optical module comprises an electrical connection portion located between the upper portion of the first circuit element and the top surface recessed portion of the casing.

10. The optical system as claimed in claim 8, wherein the upper portion of the first circuit element has a U-shaped configuration surrounding the first optical module.

11. The optical system as claimed in claim 7, further comprising a second circuit element electrically connected to the first circuit element.

12. The optical system as claimed in claim 11, wherein the casing further comprises a through hole for electrical connection between the first circuit element and the second circuit element.

13. The optical system as claimed in claim 1, further comprising an additional optical module corresponding to the first optical module.

14. The optical system as claimed in claim 13, wherein the first optical module comprises an aperture assembly, and the second optical module and the additional optical module each comprises a lens assembly.

15. The optical system as claimed in claim 14, wherein the additional optical module is disposed between the first optical module and the second optical module.

16. The optical system as claimed in claim 14, wherein the first optical module is disposed between the second optical module and the additional optical module.

17. The optical system as claimed in claim 16, wherein at least one of the second optical module and the additional optical module is at least partially disposed within the first optical module.

18. The optical system as claimed in claim 1, wherein the first optical module comprises a supporting pad disposed on the immovable part.

19. The optical system as claimed in claim 1, further comprising a drive assembly driving the movable part to move relative to the immovable part and an elastic assembly configured to provide an elastic force to the movable part, wherein the drive assembly comprises a plurality of coils, a surrounding coil surrounding the movable part, and a plurality of magnetic elements, and the elastic assembly comprises a plurality of upper elastic elements, a plurality of extending elastic elements each connected to the corresponding upper elastic element, and a plurality of lower elastic elements.

20. The optical system as claimed in claim 19, further comprising a sensing assembly sensing the movement of the movable part relative to the immovable part.
